(19) United States
(12) Patent Application Publication
(10) Pub. No.: US 2021/0270320 A1
(43) Pub. Date: Sep. 2, 2021

(54) TWO-PIECE BEARING CAGE ASSEMBLY

(71) Applicant: Schaeffler Technologies AG & Co. KG, Herzogenaurach (DE)

(72) Inventors: Michael White, Lake Wylie, SC (US); Michael Conlin, Rock Hill, SC (US); Chris Hutchison, Gastonia, NC (US); Scott Hart, Sharon, SC (US); Eric Ovendorf, Weddington, NC (US)

(73) Assignee: Schaeffler Technologies AG & Co. KG, Herzogenaurach (DE)

(21) Appl. No.: 17/186,961

(22) Filed: Feb. 26, 2021

Related U.S. Application Data
(60) Provisional application No. 62/982,416, filed on Feb. 27, 2020.

(51) Int. Cl. F16C 33/46; F16C 33/50

(52) U.S. Cl. CPC F16C 33/467; F16C 33/504

(57) ABSTRACT

An improved bearing cage is disclosed herein. The bearing cage assembly generally consists of two cage halves that are connected, fixed, or joined to each other directly via mating components formed integrally with the two cage halves. The cage halves are joined to each other via engagement of integrally formed sockets and posts defined on radially extending arms of the cage halves.

### INCORPORATION BY REFERENCE

This application claims priority to U.S. Provisional Patent Application No. 62/982,416, which was filed Feb. 27, 2020, and is incorporated herein by reference in its entirety.

### FIELD OF INVENTION

The present disclosure relates to bearing cage assembly.

### BACKGROUND

Bearing assemblies are used in a wide range of applications. Bearing assemblies without cages make assembly more difficult because the rolling elements are not always secured by the cages during assembly. Maintaining secure positioning of rolling elements during assembly of bearing cages can be problematic. In certain arrangements, lubricating grease or plugs between each rolling element can be used to secure the rolling elements. In other arrangements, a sleeve can be used to retain rolling elements during assembly.

Pin-type cage assemblies are one known type of bearing cage assembly that tries to address securing of the rolling elements during assembly. In use, the cage runs loosely between ends of the rolling elements and the cage is guided by the inside of the rolling elements. Pin-type cages are expensive due to the welding and mechanical fastening required to fix the cage components to each other, and are susceptible to misalignment or geometric distortion due to tolerance stack-up, improper mechanical connections or heat distortion during the welding process. The pins used by these types of cages also are prone to fatigue at the mechanical or welding joints, which can cause failure.

It would be desirable to provide a bearing cage configuration that secures rolling elements during assembly that is also inexpensive and easy to assemble.

### SUMMARY

An improved bearing cage is disclosed herein. The bearing cage assembly generally consists of two cage halves that are connected, fixed, or joined to each other directly via mating components formed integrally with the two cage halves.

The first cage half includes a first base rim and a first plurality of arms extending from the first base rim. The first plurality of arms each define a first plurality of rolling element pockets. At least one arm of the first plurality of arms defines a first socket and at least one arm of the first plurality of arms defines a first post.

The second cage half includes a second base rim and a second plurality of arms extending from the second base rim. The second plurality of arms each define a second plurality of rolling element pockets. At least one arm of the second plurality of arms defines a second socket and at least one arm of the second plurality of arms defines a second post.

The first cage half and the second cage half are joined to each other via engagement of the first socket with the second post and engagement of the first post with the second socket.

In one embodiment, the first cage half includes two additional posts and two additional sockets, and the second cage half includes two additional posts and two additional sockets. The quantity of sockets and posts can vary.

In one embodiment, the first post and the second post each include a cylindrical body and a head, and the head has an enlarged cross section compared to a cross section of the cylindrical body. This configuration provides a positive locking arrangement between the two cage halves.

In one embodiment, the first post and the second post each include a relief extending axially from an axially outermost end of the first post and the second post towards the first base rim and the second base rim.

The assembly can further include rolling elements, such as cylindrical rollers, arranged within the first plurality of rolling element pockets and the second plurality of rolling element pockets. Other types of rolling elements can be used, including needle rollers, spherical rollers, tapered rollers, etc. The spacing of the rolling elements can vary depending on the specific requirements of the bearing application.

Other features can be used to reinforce the connection between the two cage halves. For example, chemical bonding or welding can secure the first post to the second socket and the second post to the first socket.

In one embodiment, the first post and the second post are each formed as a cylindrical body having a first tapered profile, and the first socket and the second socket each include a second tapered profile that is complementary to the first tapered profile.

The arms including the first post, the first socket, the second post, and the second socket can each have an enlarged profile compared to a remainder of the first plurality of arms and the second plurality of arms.

In one embodiment, in the assembled state, (i) axial ends of the at least one arm of the first plurality of arms defining the first socket and the at least one arm of the first plurality of arms defining a first post abut (ii) axial ends of the at least one arm of the second plurality of arms defining the second socket and the at least one arm of the second plurality of arms defining the second post.

The first cage half and the second cage half are directly joined to each other without any separately formed fastener, in one aspect.

In one embodiment, the first cage half and the second cage half are identical to each other.

A method of assembling a bearing cage assembly including the two cage halves described herein is also disclosed.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1A is a perspective view of a first cage half according to the present disclosure.

FIG. 1B is a perspective view of a second cage half according to the present disclosure.

FIG. 2 is a magnified perspective view of two cage halves prior to assembly.

FIG. 3 is a magnified perspective view of the two cage halves of FIG. 2 further showing rolling elements.

FIG. 4 is a magnified perspective view of the two cage halves of FIGS. 2 and 3 in a fully assembled state.

FIG. 5 is a side cross-sectional view of the two cage halves of FIG. 4.

FIG. 6 is a magnified perspective view of two cage halves prior to assembly according to another embodiment.

FIG. 7 is a magnified perspective view of the two cage halves of FIG. 6 further showing rolling elements.

FIG. 8 is a magnified perspective view of the two cage halves of FIGS. 6 and 7 in a fully assembled state.

FIG. 9 is a perspective view in cross-section of the two cage halves of FIG. 8.

FIG. 10 is a front view of a region of a post and socket of the bearing cage assembly of FIGS. 6-9.

### DETAILED DESCRIPTION OF THE PREFERRED EMBODIMENTS

Certain terminology is used in the following description for convenience only and is not limiting. “Axially” refers to a direction along an axis (X) of an assembly. “Radially” refers to a direction inward and outward from the axis (X) of the assembly. “Circumferentially” refers to a direction extending along a curve or circumference of a respective element relative to the axis (X) of the assembly.

A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

A bearing cage assembly is disclosed herein. The bearing cage assembly generally includes a first cage half 10a, 110a and a second cage half 10b, 110b. In one embodiment, the first cage half 10a, 110a and the second cage half 10b, 110b are each configured to be directly joined to each other without the need for any separately formed fastener. A direct connection is provided between the two cage halves 10a, 110a, 10b, 110b via integrally formed posts and sockets, which are described in more detail herein.

The term socket is used generally herein to mean an opening, through hole, window, or other gap. The term post is used generally herein to mean a protrusion, extension, or other mass of material that extends from a base of the cage. One of ordinary skill in the art would understand that other mating features besides sockets and posts can be used to join the two cage halves.

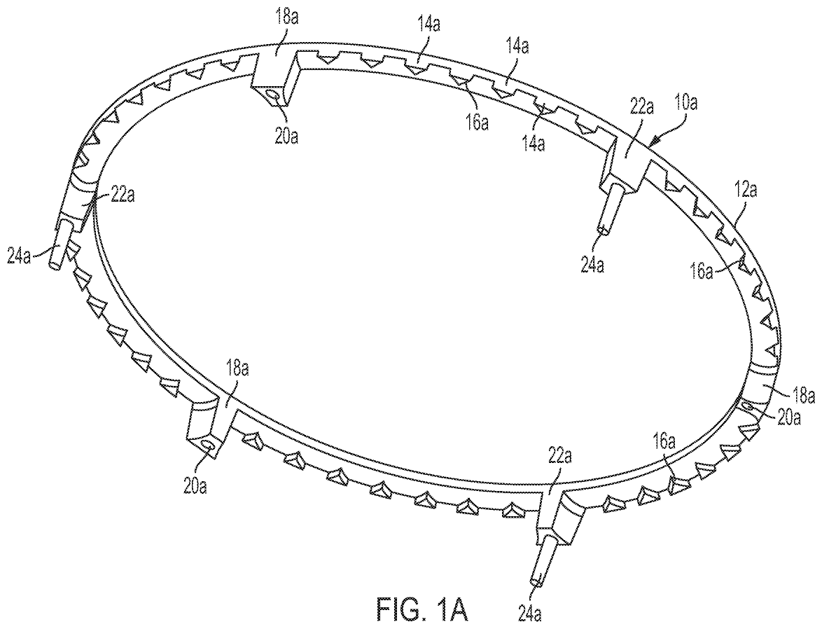

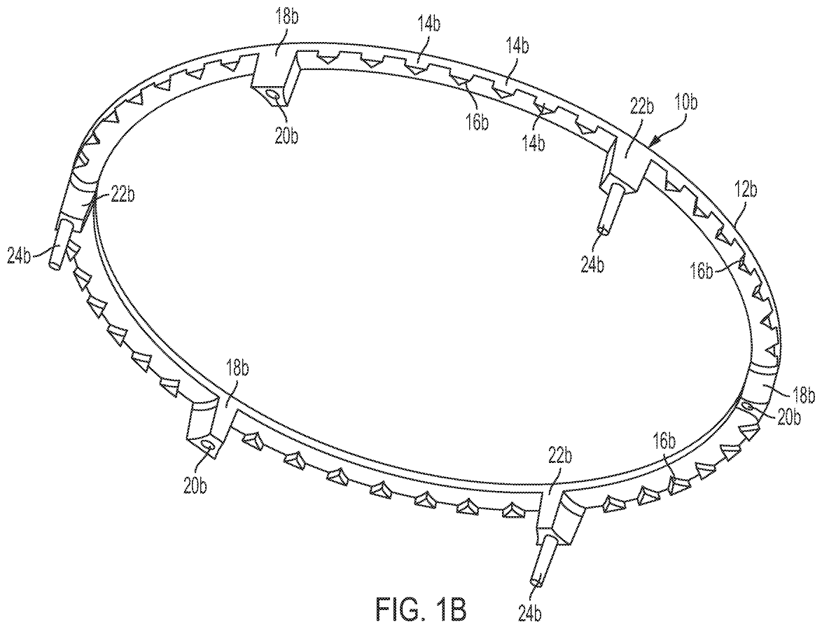

As shown in FIG. 1A, the first cage half 10a includes a first base rim 12a and a first plurality of arms 14a extending from the first base rim 12a. The first plurality of arms 14a each define a first plurality of rolling element pockets 16a. At least one arm 18a of the first plurality of arms 14a defines a first socket 20a and at least one arm 22a of the first plurality of arms 14a defines a first post 24a.

As shown in FIG. 1B, a second cage half 10b includes a second base rim 12b and a second plurality of arms 14b extending from the second base rim 12b. The second plurality of arms 14b each define a second plurality of rolling element pockets 16b. At least one arm 18b of the second plurality of arms 14b defines a second socket 20b and at least one arm 22b of the second plurality of arms 14b defines a second post 24b.

The cage halves 110a, 110b generally have the same orientation as illustrated in FIGS. 1A and 1B unless specified herein.

The first cage half 10a and the second cage half 10b are joined to each other via engagement of the first socket 20a with the second post 24b and engagement of the first post 24a with the second socket 20b. The first cage half 10a and the second cage half 10b are joined to each other without the need for any external fastening components, in one aspect.

In one embodiment, each cage half includes three sockets and three posts, which are circumferentially spaced apart from each other. One of ordinary skill in the art would understand that the number of posts and sockets can vary. By only requiring three pairs of sockets and posts, the present disclosure reduces the overall mass of the cage assembly. In one embodiment, the first cage half 10a only includes sockets and the second cage half 10b only includes posts. One of ordinary skill in the art would understand that any combination of the posts and sockets can be used.

In one embodiment, chemical bonding or welding is used to secure the first post 24a to the second socket 20b and the second post 24b to the first socket 20a.

In one embodiment, the posts 24a, 24b are each formed as a generally cylindrical body having a first tapered profile, and the sockets 20a, 20b each include a second tapered profile that is complementary to the first tapered profile. One of ordinary skill in the art would understand that these components do not need to have a tapered profile. The profiles of the sockets and posts can be designed to have any mating geometry, such as a triangle, square, pentagon, hexagon, etc. The posts and the sockets can be secured to each other via an interference fit.

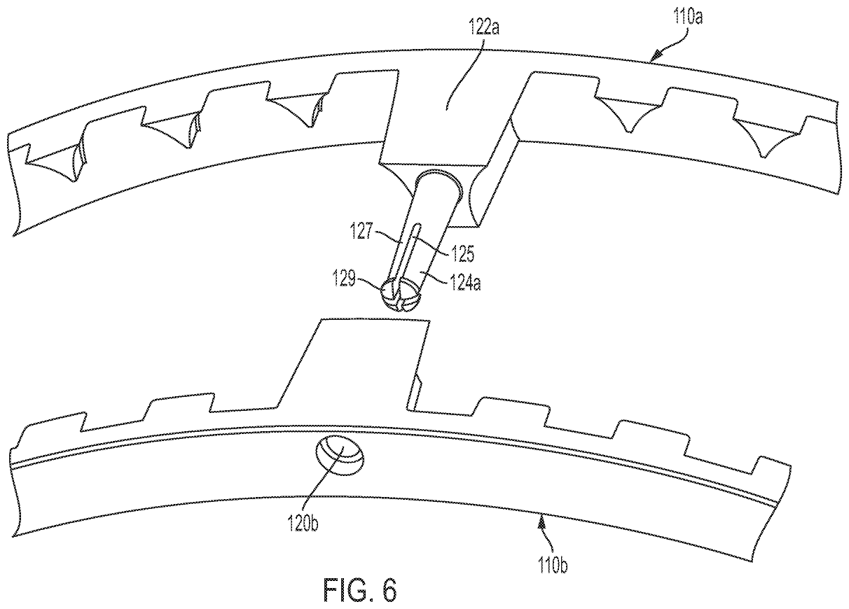

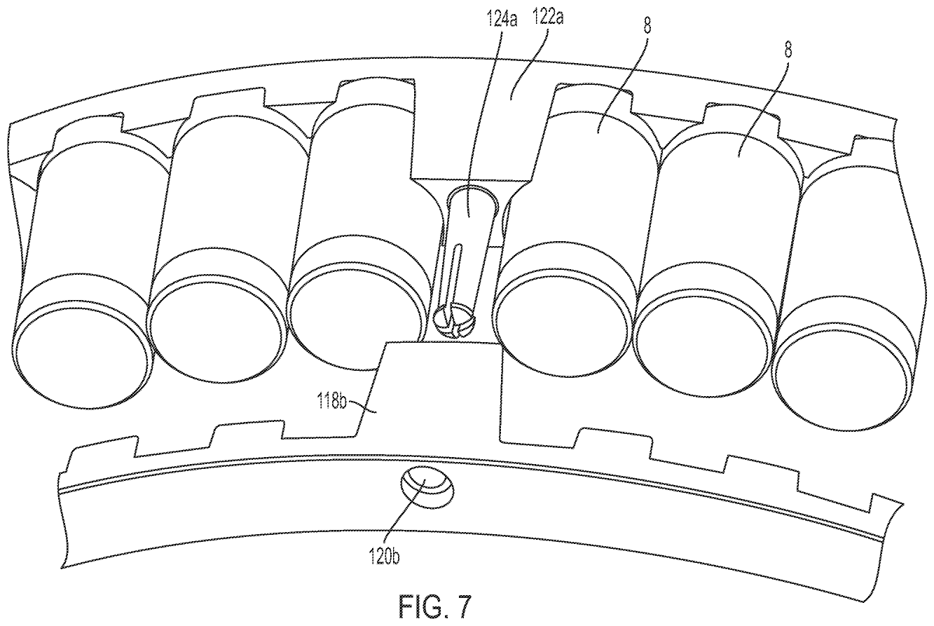

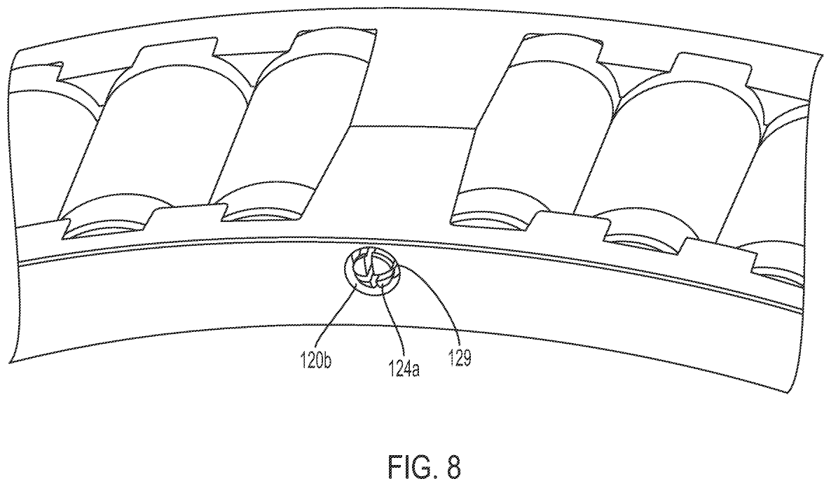

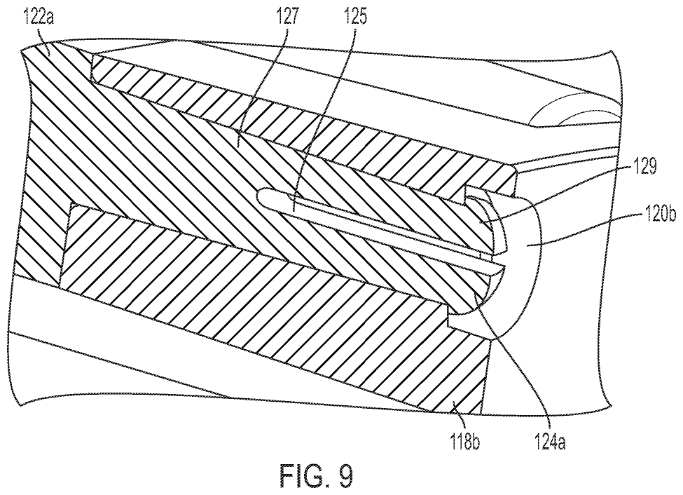

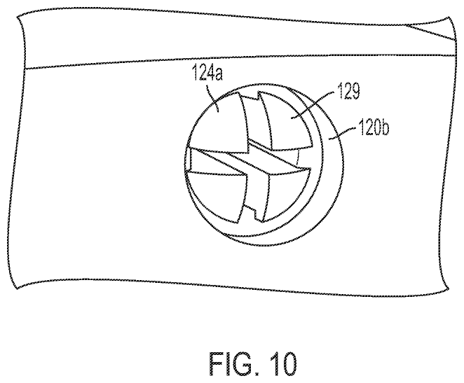

In the embodiment of FIGS. 6-10, the posts (i.e. post 124a) includes a cylindrical body 127 and a head 129. The head 129 has an enlarged cross section compared to a cross section of the cylindrical body 127. The head 129 can have a hemi-spherical rivet shape, including a relief 125 in its center for elastic deformation while passing through the sockets.

One of ordinary skill in the art would understand based on this disclosure that the head of the post can include a variety of features. For example, the head can include a threading for joining the head to a fastener or nut. The head can include a groove for a snap-ring, C-clip or other mechanical fastener. Other fastening arrangements can be provided to join the two cage halves.

The bearing cage assembly can further include cylindrical rollers 8 as the rolling elements. The cylindrical rollers 8 are arranged within the first plurality of rolling element pockets 16a and the second plurality of rolling element pockets 16b.

In one aspect, the arms 18a, 18b, 22a, 22b including the first post 24a, the first socket 20a, the second post 24b, and the second socket 20b each have an enlarged profile compared to a remainder of the first plurality of arms 14a and the second plurality of arms 14b. In other words, circumferential spacing between adjacent rolling elements 8 on either side of the arms 18a, 18b, 22a, 22b is greater than spacing between adjacent rolling elements 8 on either side of a remainder of the arms 14a, 14b.

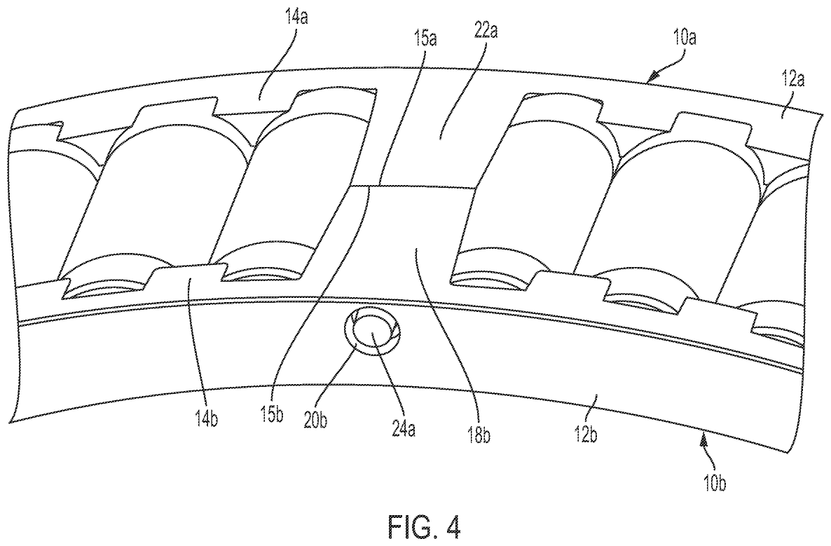

As shown in FIG. 4, axial ends 15a of the arm 18a defining the first socket 20a and the arm 22a defining a first post 24a abut axial ends 15b of the at arm 18b defining the second socket 20b and the arm 22b defining the second post 24b in an assembled state. In this arrangement, the assembled cage fully supports the rolling elements, i.e. the rolling elements are positively secured between the two cage halves 10a, 10b, 110a, 110b. This makes further assembly easier since the rolling elements are secured in place during mounting.

The circumferential extent of the arms 18a, 18b, 22a, 22b can vary depending on the particular requirements for a bearing assembly. As shown in the drawings, the circumferential extent of the arms 18a, 18b, 22a, 22b approximately corresponds to the circumferential extent of the rolling elements 8. As used in this instance, the term approximately means the circumferential extent of the arms 18a, 18b, 22a, 22b is +/−20% of the circumferential extent of the rolling elements 8.

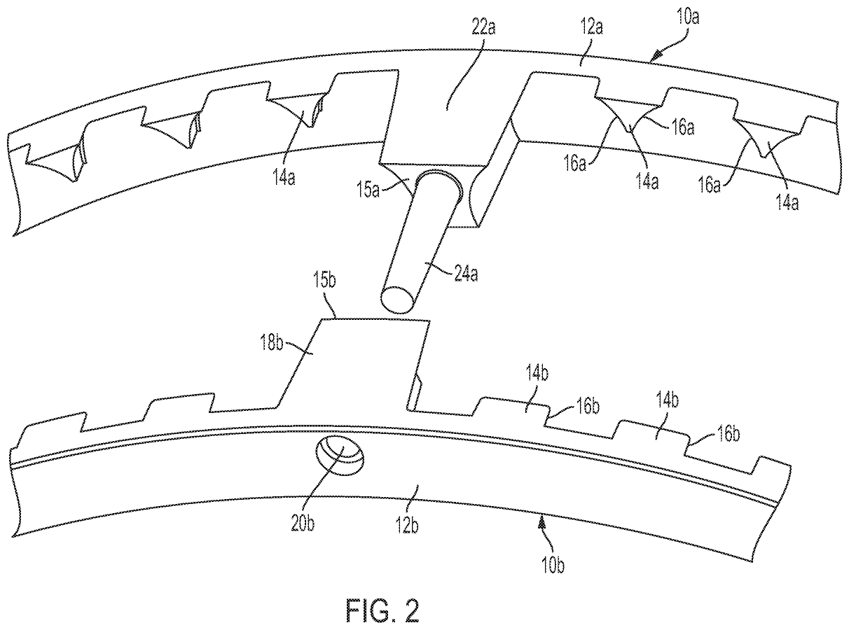

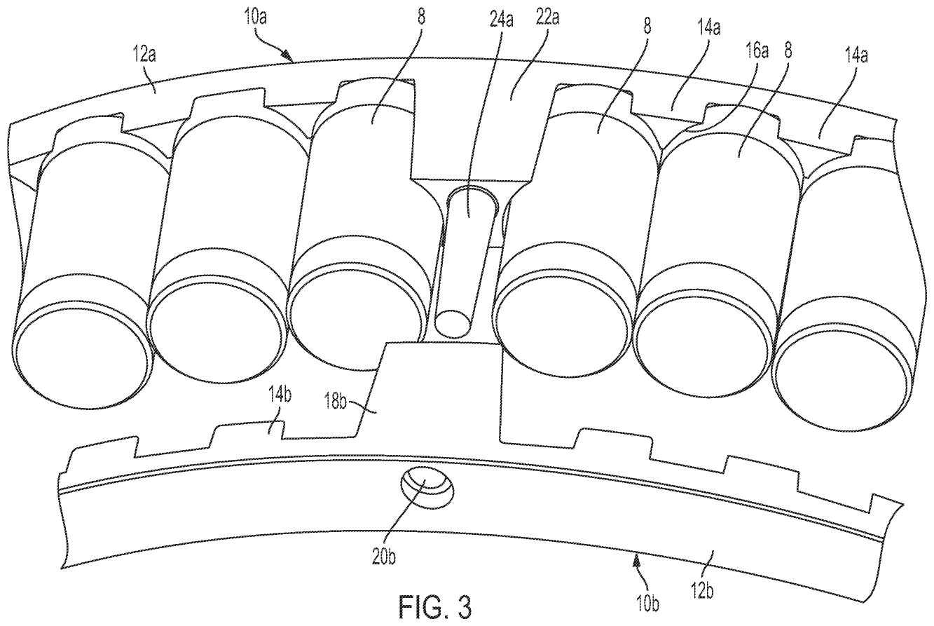

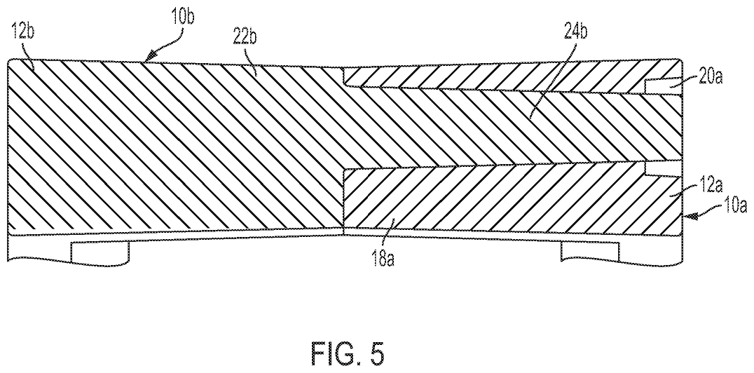

In the embodiment of FIGS. 6-10, two cage halves 110a, 110b are illustrated. The two cage halves 110a, 110b are otherwise similar to the cage halves 10a, 10b unless specified herein. Likewise, similar reference numerals are used for components of the cage halves 110a, 110b as were used for cage halves 10a, 10b, and not all components are specifically described in more detail herein. As shown in FIGS. 6-10, features on the arms are modified. Specifically, arm 122a includes a post 124a having a relief 125 extending axially from an axially outermost end of the post 124a and towards the base rim. Cage half 110b likewise includes a plurality of the same type of posts and reliefs. In other words, the cage halves 110a, 110b each include alternating posts and sockets as described with respect to FIGS. 1A-5, except the posts have a relief and enlarged head.

The relief 125 provides a degree of elastic deformation while inserting the post 124a through a socket 120b defined on an arm 118b on the cage half 110b. Once the post 124a is fully inserted, the relief 125 allows the post 124a to return to its original shape, thereby positively engaging and locking the two cage halves 110a, 110b to each other.

In one embodiment, the two cage halves 10a, 10b, 110a, 110b are identical to each other. One of ordinary skill in the art would understand based on this disclosure that the cage halves 10a, 10b, 110a, 110b do not have to be identical to other and differing configurations can be provided.

In an assembled state of one of the embodiments, the rolling elements 8 are in direct circumferential contact with each other along the generatrix, i.e. curvature, of the pitch diameter except for the rolling elements adjacent to the arms 18a, 18b including sockets and the arms 22a, 22b including posts. In other words, a majority (i.e. more than 50%) of the rolling elements 8 are in direct circumferential contact with each other. In another embodiment, spacing between the rolling elements 8 is set such that the rolling elements 8 do not touch each other. Spacing between the rolling elements 8 can be determined by the shape and geometry of the plurality of arms 14a, 14b and the pockets 16a, 16b. In another embodiment, spacing is uniformly maintained between all of the rolling elements 8, including rolling elements 8 adjacent to the arms 18a, 18b including sockets and the arms 22a, 22b including posts. One of ordinary skill in the art would understand based on this disclosure that the shape, size, and geometry of the cage halves can be selected to arrive at any desired spacing of the rolling elements 8.

A method of assembling the two cage halves 10a, 10b, 110a, 110b is also disclosed herein. The method includes providing a first cage half 10a, 110a and a second cage half 10b, 110b. The method includes joining or connecting the two cage halves 10a, 110a, 10b, 110b with each other. The cage halves 10a, 10b, 110a, 110b include a mating configuration including sockets and posts as described above.

The method includes inserting a plurality of rolling elements 8 into pockets formed between the two cage halves 10a, 110a, 10b, 110b. Once inserted, the rolling elements 8 are positively secured between the two cage halves 10a, 110a, 10b, 110b such that the bearing cage assembly and rolling elements 8 can be mounted without concern that the rolling elements 8 will become dislodged. An inner ring or bearing surface can be defined by another component that secures the rolling elements 8 within their respective pockets. One of ordinary skill in the art would understand based on this disclosure that additional or fewer method steps may be required to fully assemble the two cage halves 10a, 10b, 110a, 110b with the rolling elements 8.

The cage halves disclosed herein can be formed from plastic, metal, or any other material. Depending on the base material, the cage halves disclosed herein can be formed can be formed via molding, casting, multi-dimensional printing, fully machined or other formation methods or combination of formation methods.

Although the arms on the cage halves are shown on a radially outer region of the base rims, one skilled in the art would understand that the arms could be positioned on a radially inner region of the base rims.

Having thus described the present disclosure in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

### LOG OF REFERENCE NUMERALS

cage half 10a, 10b

base rim 12a, 12b

plurality of arms 14a, 14b

axial ends 15a, 15b of arms

pockets 16a, 16b

arms 18a, 18b including sockets

sockets 20a, 20b

arms 22a, 22b including posts

posts 24a, 24b

relief 125

cylindrical body 127

head 129

What is claimed is:

1. A bearing cage assembly comprising:
a first cage half including a first base rim and a first plurality of arms extending from the first base rim, the first plurality of arms each defining a first plurality of rolling element pockets, wherein at least one arm of the first plurality of arms defines a first socket and at least one arm of the first plurality of arms defines a first post; and
a second cage half including a second base rim and a second plurality of arms extending from the second base rim, the second plurality of arms each defining a second plurality of rolling element pockets, wherein at least one arm of the second plurality of arms defines a second socket and at least one arm of the second plurality of arms defines a second post;
wherein the first cage half and the second cage half are joined to each other via engagement of the first socket with the second post and engagement of the first post with the second socket.

2. The bearing cage assembly according to claim 1, wherein the first cage half includes two additional posts and two additional sockets, and the second cage half includes two additional posts and two additional sockets.

3. The bearing cage assembly according to claim 1, wherein the first post and the second post each include a cylindrical body and a head, wherein the head has an enlarged cross section compared to a cross section of the cylindrical body.

4. The bearing cage assembly according to claim 3, wherein the first post and the second post each include a relief extending axially from an axially outermost end of the first post and the second post towards the first base rim and the second base rim.

5. The bearing cage assembly according to claim 1, further comprising cylindrical rollers arranged within the first plurality of rolling element pockets and the second plurality of rolling element pockets.

6. The bearing cage assembly according to claim 5, wherein the cylindrical rollers positioned away from the arms defining the first and second posts and the first and second sockets are circumferentially positioned directly adjacent to each other.

7. The bearing cage assembly according to claim 5, wherein a majority of the cylindrical rollers are in direct circumferential contact with each other.

8. The bearing cage assembly according to claim 1, wherein at least one of chemical bonding or welding secures the first post to the second socket and the second post to the first socket such that the first and second cage halves are fixed to each other.

9. The bearing cage assembly according to claim 1, wherein the first post and the second post each are formed as a cylindrical body having a first tapered profile, and the first socket and the second socket each include a second tapered profile that is complementary to the first tapered profile.

10. The bearing cage assembly according to claim 1, wherein the arms including the first post, the first socket, the second post, and the second socket each have an enlarged profile compared to a remainder of the first plurality of arms and the second plurality of arms.

11. The bearing cage assembly according to claim 1, wherein in an assembled state, (i) axial ends of the at least one arm of the first plurality of arms defining the first socket and the at least one arm of the first plurality of arms defining a first post abut (ii) axial ends of the at least one arm of the second plurality of arms defining the second socket and the at least one arm of the second plurality of arms defining the second post.

12. The bearing cage assembly according to claim 1, wherein the first cage half and the second cage half are directly joined to each other without any separately formed fastener.

13. The bearing cage assembly according to claim 1, wherein the first cage half and the second cage half are identical to each other.

14. The bearing cage assembly according to claim 1, wherein the first cage half and the second cage half are each formed from plastic.

15. A bearing cage assembly comprising:
two cage halves that each include:
a base rim and a plurality of arms extending from the base rim, the plurality of arms each defining one half of a plurality of rolling element pockets,
at least two sockets and at least two posts, wherein the at least two sockets and the at least two posts are formed on enlarged arms of the plurality of arms;
wherein the two cage halves are connected directly to each other via engagement of the at least two posts on a first cage half of the two cage halves with the at least two sockets on a second cage half of the two cage halves, and engagement of the at least two sockets on the first cage half with the at least two posts of the second cage half.

16. The bearing cage assembly according to claim 15, wherein the first cage half and the second cage half are identical to each other.

17. The bearing cage assembly according to claim 15, wherein the first cage half and the second cage half are directly joined to each other without any separately formed fastener.

18. The bearing cage assembly according to claim 15, wherein the posts each include a cylindrical body and a head having an enlarged cross section compared to a cross section of the cylindrical body, and the posts each include a relief extending axially from an axially outermost end of the posts.

19. The bearing cage assembly according to claim 15, wherein the posts each are formed as a cylindrical body having a first tapered profile, and the sockets each have a second tapered profile that is complementary to the first tapered profile.

20. A bearing cage assembly comprising:
two cage halves that each include a plurality of arms extending from a base rim, each arm of the plurality of arms partially defines a rolling element pocket,
at least one first arm of the plurality of arms on a first cage half of the two cage halves includes a socket, and at least one second arm of the plurality of arms on a second cage half of the two cage halves includes a post, such that the two cage halves are connected to each other by insertion and retention of the post within the socket.
